(19) United States
(12) Patent Application Publication
(10) Pub. No.: US 2005/0231314 A1
(43) Pub. Date: Oct. 20, 2005

(54) Magnetizing device

(75) Inventor: Thomas Haisch, Tuttlingen (DE)

Correspondence Address: Lipsitz & McAllister, LLC, 755 MAIN STREET, MONROE, CT, 06468, US

(73) Assignee: Minebea Co., Ltd., Nagano-ken (JP)

(21) Appl. No.: 11/106,347

(22) Filed: Apr. 13, 2005

(30) Foreign Application Priority Data
Apr. 14, 2004 (DE) 10 2004 018 963

(51) Int. Cl. H01F 1/03

(52) U.S. Cl. 335/284

(57) ABSTRACT

In order to improve the useful life of a magnetizing device comprising a housing, a magnetizing head held on the housing, the magnetizing head having a magnetizing finger extending in the direction of the longitudinal axis in which at least one magnetizing coil and at least one coil core are disposed, and a cooling device to cool the magnetizing finger, it is proposed that a temperature sensor coupled to a control is disposed in the magnetizing head and that when the temperature sensor measures a temperature in the magnetizing finger that lies above an upper temperature threshold (GT), the control prevents a magnetizing process from taking place.

The present disclosure relates to the subject matter disclosed in German application No. 10 2004 018 963.3 of Apr. 14, 2004, which is incorporated herein by reference in its entirety and for all purposes.

### BACKGROUND OF THE INVENTION

The invention relates to a magnetizing device comprising a housing, a magnetizing head held on the housing, the magnetizing head having a magnetizing finger that extends in the direction of the longitudinal axis in which at least one magnetizing coil as well as at least one coil core are disposed, and a cooling device to cool the magnetizing finger.

Such magnetizing devices are known in the prior art.

Since the magnetizing finger normally requires intensive cooling, large fluctuations in temperature occur which particularly go to reduce the useful life of the magnetizing head of the magnetizing device.

The object of the invention is therefore to improve the useful life of a magnetizing device of this generic type.

### SUMMARY OF THE INVENTION

This object has been achieved for a magnetizing device of the type described in the opening paragraph in accordance with the invention in that a temperature sensor coupled to a control is disposed in the magnetizing head and that the control prevents a magnetizing process from taking place when the temperature sensor measures a temperature in the magnetizing finger that lies above an upper temperature threshold.

The advantage of the solution according to the invention therefore lies in the fact that by using the control, overheating of the magnetizing head can be prevented in that the heat input is reduced by blocking the magnetizing process thus providing the opportunity of making sufficient time available for the magnetizing finger to be cooled by means of the cooling device and consequently for a reduction in the temperature in the magnetizing finger.

In principle, there would be the possibility of blocking a magnetizing process for a specific period of time for reasons of safety, thus providing sufficient time for the magnetizing finger to cool down.

However, to ensure particularly high efficiency when working with the magnetizing device according to the invention, it is preferable if the control allows a magnetizing process to take place again when the temperature in the magnetizing finger falls below a temperature threshold.

The temperature threshold may be set, for example, so that it lies considerably below the upper temperature threshold.

However, to ensure that the magnetizing process is only blocked for the shortest possible time, it is preferable if the temperature threshold is approximately identical to the upper temperature threshold so that only a switching hysteresis occurs which is determined by the system-related hysteresis of the temperature sensor and the control.

It is basically conceivable that a magnetizing process be prevented by interrupting the connection between a power source for the magnetizing coil and the magnetizing coil.

However, since these kinds of power sources are usually pulsed current sources, it is preferable when the upper temperature threshold is exceeded, if a current pulse of a pulsed current source for the at least one magnetizing coil can be blocked using the control, i.e. the pulsed current source is controlled in such a way that it does not deliver any more current pulses.

In the solution according to the invention as described up to this point, only a means of preventing the upper temperature threshold from being exceeded and consequent damage to the magnetizing finger has been provided.

However, if there is intensive cooling of the magnetizing finger, there is also the risk that the functioning of the cooling device may be impaired or that the useful life of the magnetizing finger may also be limited due to the intensive cooling.

For this reason, it is preferable if the control includes a means of regulation through which the cooling device can be controlled and through which the temperature in the magnetizing finger measured by the temperature sensor can be regulated within an acceptable range.

This provides the possibility of keeping the temperature in the magnetizing finger within the acceptable range, particularly when the heat input produced by the magnetizing processes is low or when there are no magnetizing processes at all.

It is then preferable if the acceptable range lies above freezing point so that simply by setting the acceptable range, the formation of ice in the region of the cooling device can be prevented.

It is particularly favorable if the acceptable range lies between an upper and a lower target value threshold, within which a hysteresis can be set which also takes account of the regulatory inertia of the cooling device.

However, to avoid having to design the cooling capacity of the cooling device with such large dimensions so as to make it capable of absorbing every possible heat input produced by the magnetizing processes through the cooling capacity without a rise in temperature, it is preferable if a permitted operating range lies between the acceptable range and the upper temperature threshold.

This means that an operating range is provided for the temperature in the magnetizing finger that lies above the acceptable range, so that the cooling device cools with maximum cooling capacity but cannot prevent the temperature in the magnetizing finger from rising above the acceptable range.

According to the invention, the permitted operating range—as already explained at the outset—is only limited by the prevention of a further magnetizing process, and thus further heat input, when the upper temperature threshold is exceeded.

So far, no precise details have been given concerning the design of the cooling device itself. It is conceivable, for example, that the magnetizing finger be cooled from at least two sides.

An embodiment that is particularly favorable due to its simplicity provides for the cooling device to only dissipate heat on one side of the magnetizing finger, so that the entire heat from the magnetizing finger is only absorbed from one side of the magnetizing finger.

This can be achieved in a particularly favorable way if the cooling device comprises a cooling body which is thermally coupled to the coil core.

A particularly favorable method of coupling the cooling body to the coil core can preferably be achieved in that the cooling body is coupled to the coil core through physical contact.

It is basically conceivable for the cooling device to function as a water cooling system and consequently use water to cool the cooling body.

Another possibility is for the cooling device to operate with a Peltier element.

A particularly favorable embodiment of a cooling device according to the invention provides that a cooling body of the cooling device comprises a cooling surface carrier that can have a cooling gas applied to it. The use of cooling gas is particularly advantageous if the cooling device according to the invention is employed in clean rooms.

The cooling device according to the invention operates particularly efficiently with cooling gas if the cooling surface carrier is designed to deflect the cooling gas thus ensuring an excellent transfer of heat from the cooling surface carrier to the cooling gas.

A particularly suitable embodiment provides that the cooling surface carrier has a hollow body and that cooling gas can be applied to its cooling surfaces.

The cooling gas can be produced using various methods.

For example, gas from a central gas supply can be simply employed at room temperature.

However, a particularly favorable solution provides that the cooling gas is a cold gas from a cold gas flow produced through the adiabatic expansion of a gas.

Such adiabatic expansion of the gas could be produced, for example, by using a nozzle.

A particularly suitable solution for generating the cold gas flow provides that the cold gas flow is produced through irreversible adiabatic expansion according to the Joule-Thomson Effect.

A particularly favorable cooling effect can be achieved if the cold gas flow has a temperature of less than 0° Celsius.

In the context of the previous explanations of the individual embodiments, no precise details have as yet been given on the arrangement of the temperature sensor. The temperature sensor can basically be disposed in the magnetizing finger in any desired location.

To ensure that the temperature measured by the temperature sensor is not lower than the actual temperature prevailing, for example, in the region of the magnetizing coils, it is preferable if the temperature sensor is disposed on the opposite side of the magnetizing finger to the side on which the heat is dissipated by the cooling device.

In this context, the temperature sensor could be seated directly on the coil core.

However, measuring the temperature is made particularly reliable if the temperature sensor is in thermal contact with an encapsulating material surrounding the coil core since the magnetizing coils are also usually embedded in this encapsulating material surrounding the coil core and so it can be assumed that the temperature conditions measured by the temperature sensor approximately correspond to the temperature conditions in the region of the magnetizing coils.

It is particularly favorable in this respect if the temperature sensor is disposed close to a second end of the coil core located opposite a first end of the coil core that is cooled by the cooling device.

Further characteristics of the invention form the subject matter of the description below as well as the illustration in drawings of an embodiment.

### BRIEF DESCRIPTION OF THE DRAWINGS

FIG. 1 a perspective overall view of a magnetizing device according to the invention,

FIG. 2 a section along line 2-2 in FIG. 1;

FIG. 3 an enlarged longitudinal view through a magnetizing head similar to FIG. 2;

FIG. 4 a section along line 4-4 in FIG. 3;

FIG. 5 a schematic view of the mode of operation of a control and

FIG. 6 a diagram showing an exemplary waveform of the temperature in a magnetizing finger when the control is activated.

### DETAILED DESCRIPTION OF THE INVENTION

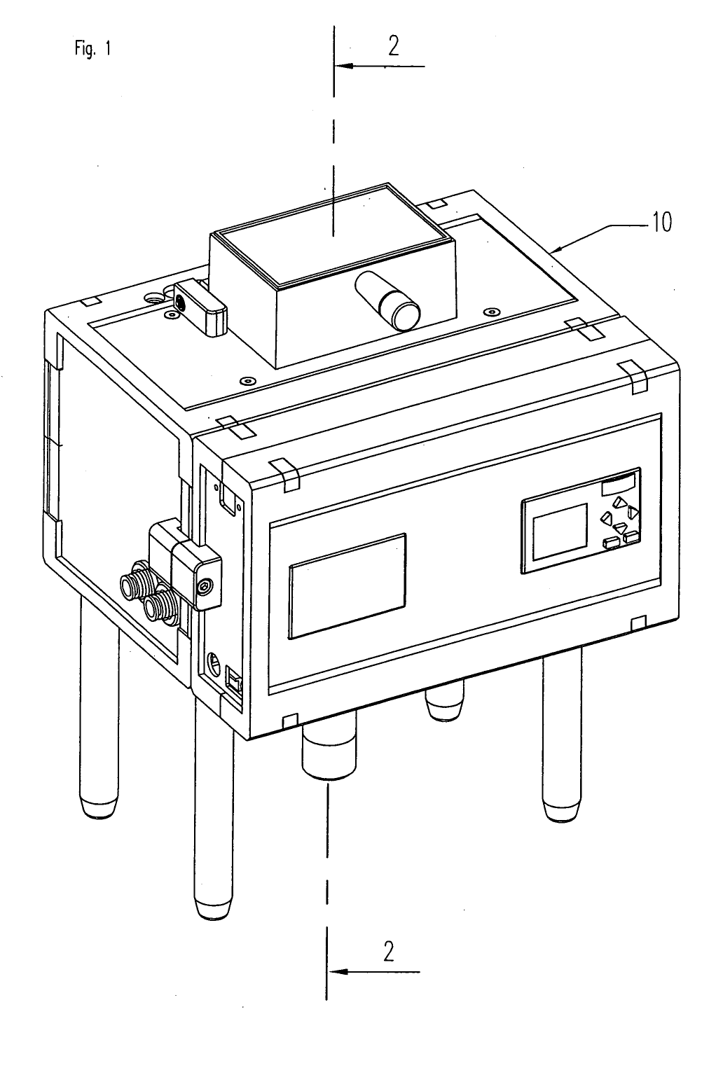

An embodiment of a magnetizing device according to the invention, illustrated in FIGS. 1 to 3, comprises a housing, indicated in its entirety by 10, in which a magnetizing head, indicated by 12, is disposed, a magnetizing finger 14 of the magnetizing head projecting from a topside 16 of the housing 10 so that annular bodies 18 that are to be magnetized by the magnetizing device can be slid onto the magnetizing finger 14, the annular bodies 18 encompassing the magnetizing finger 14 on its sleeve side 20.

As a safety precaution for the operator, a covering lid 22 is disposed on the topside 16 of the housing 10, the covering lid 22 being mounted rotatably about an axis 24 and, in its closed position, extending beyond the magnetizing finger 14 that projects above the topside 16, and overlaps the magnetizing finger 14, extending as far as the topside 16 of the housing 10.

Furthermore, a control 28 for the intended functions, which particularly include the magnetizing processes to be carried out, is disposed on a front side 26 of the housing 10. The control 28, for example, only allows a magnetizing process to take place when the covering lid 22 is in its closed position. Further functions according to the invention will be explained in more detail below.

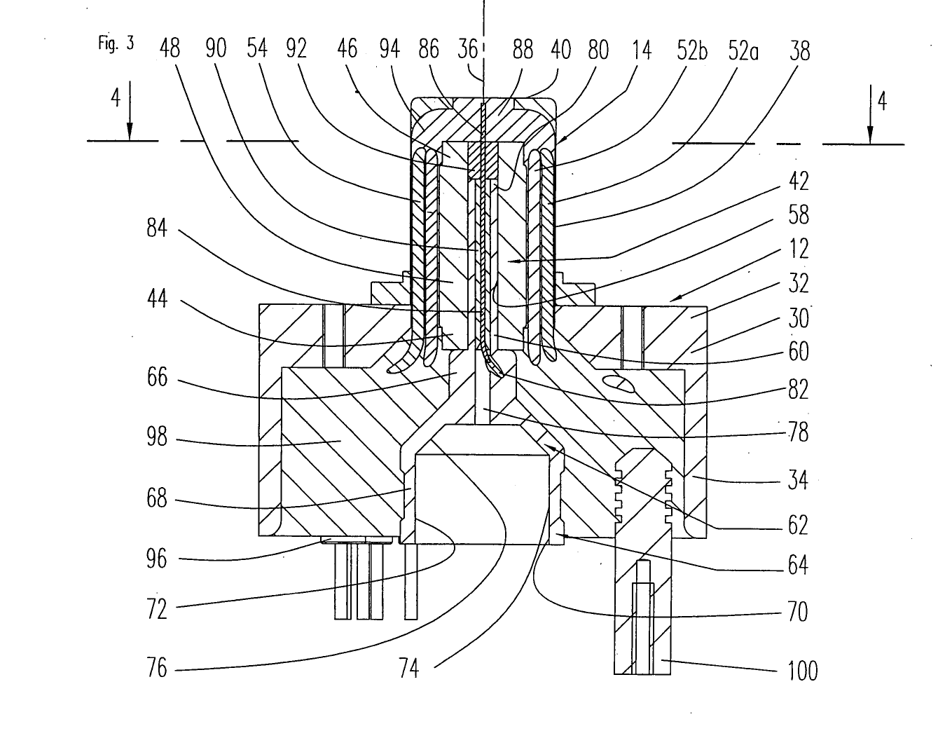

As illustrated in FIG. 3, the magnetizing head 12 comprises a base housing 30, consisting of a base plate 32 and a housing cup 34 extending away from the base plate 32.

Moreover, starting from the base plate 32 of the base housing 30 on the opposite side from the housing cup 34, the housing sleeve 38 of the magnetizing finger 14 running coaxial to the longitudinal axis 36 extends as far as a lid 40 that seals the housing sleeve 38 on the side located opposite the base housing 30.

The housing sleeve 38 encloses a coil core 42 disposed inside said housing sleeve 38, the coil core 42 likewise extending in the direction of the longitudinal axis 36 from a first end 44 located in the base housing 30 to a second end 46 facing the lid 40.

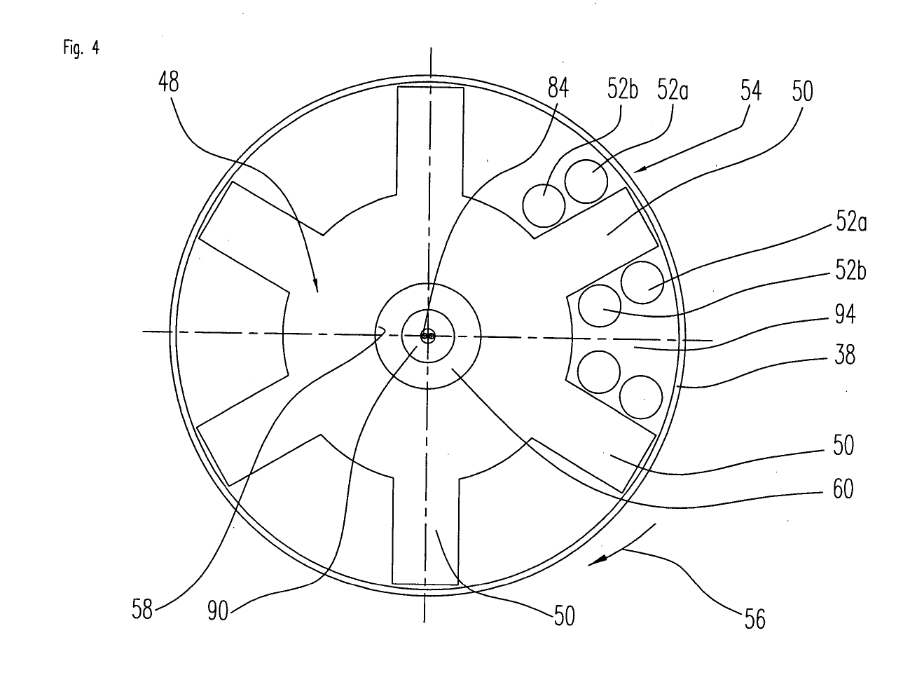

As illustrated in FIG. 4, the coil core 42 has a cylindrical core body 48 from which magnetic poles 50 extend in a direction radial to the longitudinal axis 36 as far as the housing sleeve 38, each magnetic pole 50 being encompassed by windings 52, for example windings 52a, 52b, of a magnetizing coil 54, which, seen from the direction of rotation 56, are located between the magnetic poles 50 and, seen in a direction radial to the longitudinal axis 36, are located between the core body 48 and the housing sleeve 38. This means that when all the magnetizing coils 54 are energized, magnetic poles 50 being disposed one after the other in the direction of rotation 56 and having different polarities are provided.

For its part, the core body 48 also has an aperture 58 running coaxial to the longitudinal axis 36 which extends throughout the core body 48 from the first end 44 to the second end 46.

A tubular extension 60 of a cooling body 62, indicated in its entirety by 62, is seated in this aperture 58, the cooling body 62 also having a cooling surface carrier 64 adjoining the extension 60 after the first end 44 of the coil core 42, the cooling surface carrier 64 being seated within the housing cup 34 and, in the illustrated embodiment, having an intermediary body 66 that carries the extension 60 and abuts the first end 44 of the coil core 42, and having a hollow body 68 adjoining the intermediary body 66. The cooling body 62 is thermally coupled to the coil core 42 through physical contact, thus allowing the heat building up in the coil core 42 to be conducted as effectively as possible to the cooling body 62.

The hollow body 68 has an opening 70 facing away from the coil core 42 and a cooling surface 72 extending from the opening 70 into the hollow body 68, the hollow body 68, for example, being transformed from a region 74 adjoining the opening 70 and running cylindrical to the longitudinal axis 36 into a tapered, funnel-shaped region 76 running conical to the longitudinal axis 36.

A central channel 78 penetrates the entire cooling body 62, starting at the tapered conical region 76 and extending through the intermediary body 66 and the extension 60 as far as an opening 80 in the extension 60, which is arranged to face the second end 46 of the coil core 42.

Furthermore, a bore 82 leading through the intermediary body 66 towards the outside also runs into the channel 78, a pipe 84 being led through this bore from an outer surface of the intermediary body 66 into the channel 78, the pipe 84 extending throughout the channel 78 as far as the opening 80 and emerging from the opening 80 in order to reach a temperature sensor 86 that is seated in an encapsulated area 88 adjoining the second end 46 of the coil core 42 and disposed between this second end 46 and the lid 40.

The pipe 84 running through the channel 78 is furthermore insulated with respect to the extension 60 by an insulating sleeve 90 and in addition to this it is insulated after the extension 60 by a sealing plug 92 which seals the aperture 58 in the coil core 42 in the region of the second end 46.

The encapsulated area 88 and all the spaces between the magnetizing coils 54 about the coil core 42 are filled with an encapsulating material 94 as illustrated in FIGS. 3 and 4.

The individual windings 52a, b of the magnetizing coils 54 protrude from the magnetizing finger 14 on the side towards the base housing 30 and are electrically connected to contact elements 96 that are disposed in the housing cup 34 about the cooling surface carrier 64 and kept insulated from one another in the housing cup 34 by an encapsulating material 98.

External connections 100 are further provided for the power supply to the magnetizing coils 54, by means of which all magnetizing coils 54 are supplied with power at the same time.

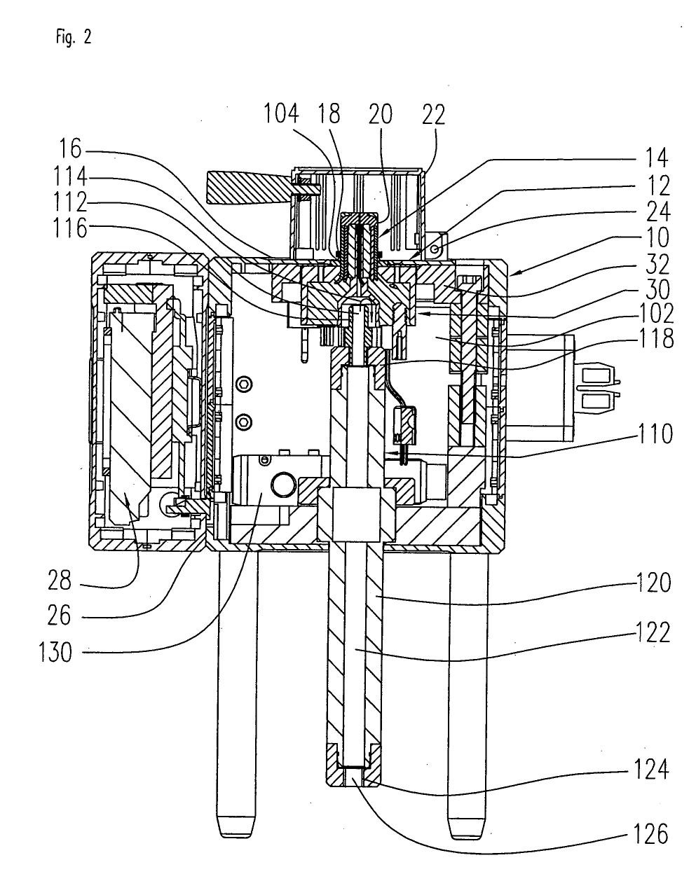

As additionally illustrated in FIG. 2, the magnetizing head 12 is likewise held on the topside 16 of the housing 10 and in such a way that the magnetizing head 12 rests against the topside 16 with the base plate 32 of the base housing 30, the base housing 30 being located in an inner space 102 of the housing 10, whereas the magnetizing finger 14 protrudes through an opening 104 provided in the topside 16 of the housing 10 and thus projects above the topside 16 as described above.

To cool the cooling surface carrier 64 in the region of its cooling surface 72, cold gas generated by a cold air generator 110, in the simplest case cold air, is blown into the hollow body 68 in the form of a flow of cold air 114 discharged from an opening 112 in the cold air generator 110 and absorbs the heat from the cooling body 62 via the cooling surfaces 72 of the hollow body 68.

The opening 112 is preferably seated on a nozzle piece 116 projecting into the hollow body 68 through the opening 70, so that the flow of cold air 114 is applied to the cooling surfaces 72, first in the conical region 76 and then in the cylindrical region 74, and flows along the outside of the nozzle piece 116 in the direction of the opening 70 and is discharged again from the hollow body 68, via the opening 70, a flow-guiding element 118 being disposed to adjoin the opening 70 for the purpose of distributing the discharged cold air flow 114, which then allows the cold air flow 114 to be discharged into the inner space 102 of the housing 10 and to be distributed in this inner space 102.

The cold air flow 114 discharged from the opening 112 preferably has a temperature below freezing point, even more preferably, a temperature lower than −10° Celsius. Most preferable of all, work is carried out at temperatures in the magnitude of −20° Celsius.

To generate the cold air flow 114 at such a low temperature, the cold air generator 110 is designed as a cold air generator based on the Joule-Thomson Effect, i.e. based on irreversible adiabatic expansion, that comprises a tubular body 120 in whose inner space 122 irreversible adiabatic expansion takes place including the creation of turbulence, the cold air flow 114 being discharged from one side of the tubular body 120, namely via the opening 112, and a hot air flow 126 being discharged from the opposite side via an opening 124.

The cold air generator is arranged in such a way that the end bearing the opening 112 is located within the housing 10 while the end bearing the opening 124 is located outside the housing 10.

Air is supplied to the cold air generator 110 via an on-off valve 130 that is disposed in the housing 10 and in the simplest case is capable of switching the air flow supplied to the cold air generator 110 off or on. However, it is also possible to design the on-off valve 130 in such a way that enables the amount of air supplied to the cold air generator 110 to be variably adjusted.

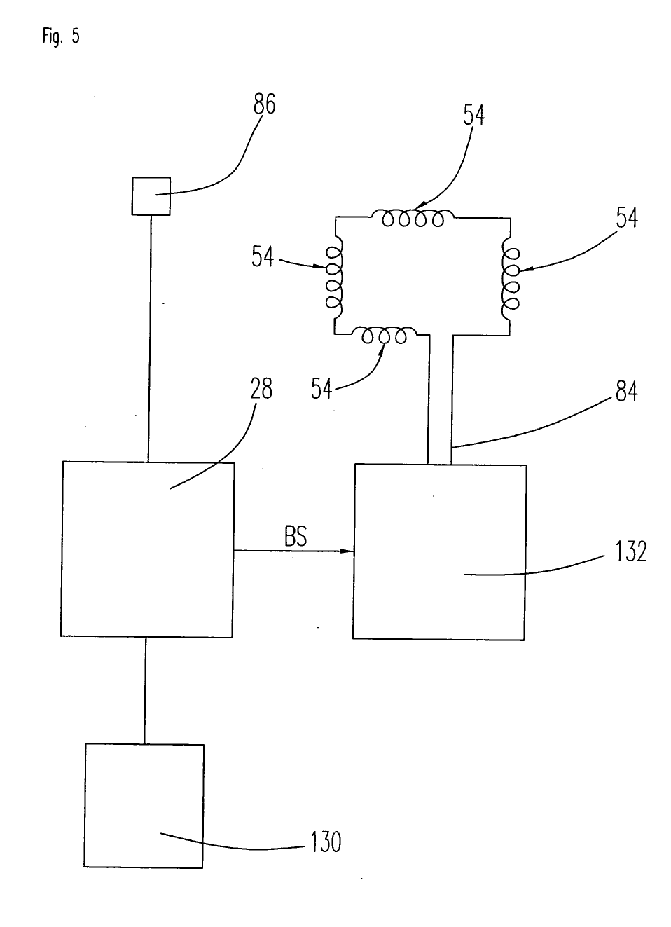

As illustrated in FIG. 5, not only can the control 28 regulate the on-off valve 130 for the air flowing to the cold air generator 110, but also a pulsed current source 132 to generate the current flowing through the magnetizing coils 54.

The control 28 is further coupled to the temperature sensor 86.

The control 28 measures the temperature in the magnetizing finger 14 via the temperature sensor 86, namely in the region of the second end 46 of the coil core 42 on a side of the coil core 42 located opposite to where heat is dissipated by the cooling body 62.

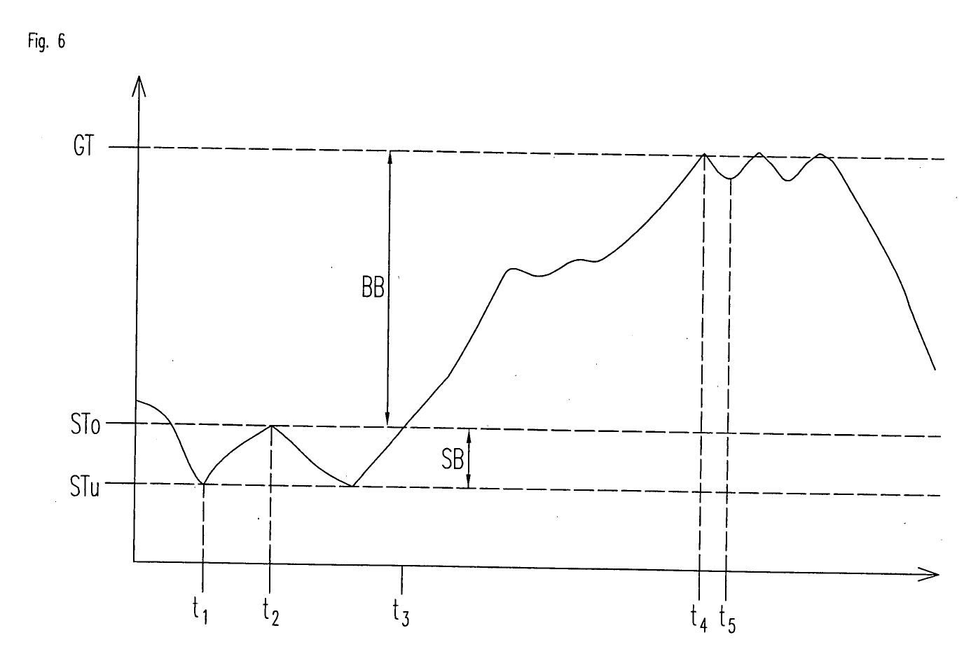

On the one hand, the control 28 operates as a temperature regulator by drawing on the temperature in the magnetizing finger 14 measured by the temperature sensor 86, in that it compares the temperature measured by the temperature sensor 86 with a temperature of an acceptable range SB. The acceptable range SB is prescribed by a lower target value threshold STu and an upper target value threshold STo, with which the temperature measured by the temperature sensor 86 is compared. If the temperature measured by the temperature sensor 86 lies above the upper target value threshold STo, the control 28 switches the cold air generator 110 on for as long as it takes the temperature measured by the temperature sensor 86 to attain the lower target value threshold STu through the cooling body 62 being cooled, and when the lower target value threshold STu has been reached the cold air generator 110 is switched off as shown in FIG. 6 at time t₁.

As long as the temperature measured bythe temperature sensor 86 then lies between the lower target value threshold STu and the upper target value threshold STo, the cold air generator 110 is not switched on by the control 28.

It is only when the temperature measured by the temperature sensor 86 exceeds the upper target value threshold STo that the cold air generator 110 is switched on, as shown in FIG. 6 at time t₂, and remains on until the temperature measured by the temperature sensor 86 has reached the temperature of the lower target value threshold STu (FIG. 6).

The upper target value threshold STo is a temperature lying, for example, in the range between approximately 15° Celsius and approximately 25° Celsius, preferably at approximately 20° Celsius, while the lower target value threshold STu, for example, lies in the range between approximately 5° Celsius and approximately 15° Celsius, preferably at approximately 10° Celsius.

This method of regulating the temperature in the magnetizing finger 14 using the control 28, where the cold air generator 110 is switched on or off, attains its full effectiveness when the magnetizing device according to the invention is operated under partial load, i.e. when the magnetizing cycles for the annular bodies 18 do not follow one another incessantly.

If the magnetizing device according to the invention is operated so that the magnetizing cycles follow each other at the shortest possible intervals, it is possible, as also illustrated in FIG. 6, that from a time t₃ for example, a temperature will occur in the magnetizing finger 14 that may lie above the upper target value threshold STo of the acceptable range SB. As shown in FIG. 6, directly above the acceptable range SB lies a permitted operating range BB within which temperatures may occur in the magnetizing finger 14 which are permitted without entailing any long-term damage to the magnetizing head 12 and, in particular, any long-term damage to the magnetizing finger 14.

The permitted operating range BB extends between the upper target value threshold STo and below an upper temperature threshold defined by an upper maximum temperature GT in the magnetizing finger 14.

If a temperature in the magnetizing finger 14 is measured by the temperature sensor 86, for example at t₄, which lies above the upper maximum temperature GT, the control 28 then generates a blocking signal BS which is fed to the pulsed current source 132 and here ensures that the pulsed current source 132 does not generate any further power pulses for the purpose of carrying out magnetizing cycles in the magnetizing finger 14, i.e. the blocking signal BS blocks the generation of any further power pulses for the magnetizing coils 54.

This blockage of the pulsed current source 132 lasts for as long as it takes the temperature in the magnetizing finger 14 measured by the temperature sensor 86 to be reduced by the cold air generator 110 to the extent that this temperature lies below the upper maximum temperature GT, as shown at t₅. Switching off the blocking signal BS by means of the control 28 enables the power source 132 to function once again and allows the power source 132 to again generate successive power pulses for successive magnetizing cycles.

The upper maximum temperature GT preferably lies in the range between approximately 40° Celsius and 60° Celsius, most favorably in the magnitude of approximately 50° Celsius.

Due to the described regulation for the temperature in the magnetizing finger 14, when the magnetizing finger 14 is operated at temperatures lying within the permitted operating range BB, the cold air generator 110 is always fully switched on by the control 28 and applies its full cooling capacity to the cooling element 62, however, due to the high heat input, the acceptable range SB cannot be reached when the magnetizing cycles follow each other at short intervals.

This means that as soon as there are longer intervals between the magnetizing cycles, for example, the temperature in the magnetizing finger 14 will become lower and approach the acceptable range SB. Temperatures within the acceptable ranges SB are generally only achieved when there are no magnetizing cycles or only sporadic magnetizing cycles.

The control 28 according to the invention thus makes it possible for the temperatures occurring in the magnetizing finger 14 to be kept within the acceptable range SB when the heat input created by magnetizing cycles into the magnetizing finger 14 is low, however, it is also able to prevent the temperatures in the magnetizing finger 14 and in the cooling body 62 from falling below freezing point and thus to prevent icing from occurring in the region of the cooling surfaces 72 due to the low temperature of the cold air flow 114.

On the other hand, the control 28 according to the invention prevents excessive heating of the magnetizing finger 14, which would decrease the useful life of the magnetizing coils 54, wherein by simply blocking the pulsed, current source 132, the heat input into the magnetizing finger 14 can be limited when the temperature exceeds the upper maximum temperature GT, in order to provide sufficient time for the magnetizing finger 14 to cool down using the cold air generator 110 and the cooling body 62.

### IDENTIFICATION REFERENCE LIST

10 Housing
12 Magnetizing head
14 Magnetizing finger
16 Topside
18 Annular body
20 Sleeve side
22 Covering lid
24 Axis
26 Front side
28 Control
30 Base housing
32 Base plate
34 Housing cup
36 Longitudinal axis
38 Housing sleeve
40 Lid
42 Coil core
44 First end
46 Second end
48 Core body
50 Magnetic poles
52a, b Winding
54 Magnetizing coil
56 Direction of rotation
58 Opening
60 Extension
62 Cooling body
64 Cooling surface carrier
66 Intermediary body
68 Hollow body
70 Opening
72 Cooling surface
74 Cylindrical region
76 Conical region
78 Channel
80 Opening
82 Bore
84 Pipe
86 Temperature sensor
88 Encapsulated area
90 Insulating sleeve
92 Sealing plug
94 Encapsulating material
96 Contact element
98 Encapsulating material
100 Connections
102 Inner space
104 Opening
110 Cold air generator
112 Opening
114 Cold air flow
116 Nozzle piece
118 Flow-guiding element
120 Tubular body
122 Inner space
124 Opening
126 Hot air flow
130 On-off valve
132 Pulsed current source
GT Maximum temperature
BB Operating range
SB Acceptable range
STo Upper target value threshold
STu Lower target value threshold
BS Blocking signal

1. A magnetizing device
comprising a housing,
a magnetizing head held on the housing, the magnetizing head having a magnetizing finger extending in the direction of the longitudinal axis in which at least one magnetizing coil and at least one coil core are disposed,
and a cooling device to cool the magnetizing finger,
a temperature sensor coupled to a control and disposed in the magnetizing head, the control preventing a magnetizing process from taking place when the temperature sensor measures a temperature in the magnetizing finger that lies above an upper temperature threshold.

2. A magnetizing device according to claim 1, wherein the control allows a magnetizing process to take place again when the temperature in the magnetizing finger falls below a temperature threshold.

3. A magnetizing device according to claim 1, wherein when the upper temperature threshold is exceeded, a current pulse of a power generator for the at least one magnetizing coil can be blocked using the control.

4. A magnetizing device according to claim 1, wherein the control includes a means of regulation through which the cooling device can be controlled and through which the temperature in the magnetizing finger measured by the temperature sensor can be regulated within an acceptable range.

5. A magnetizing device according to claim 4, wherein the acceptable range lies above freezing point.

6. A magnetizing device according to claim 4, wherein the acceptable range lies between an upper and a lower target value threshold.

7. A magnetizing device according to claim 4, wherein a permitted operating range lies between the acceptable range and the upper temperature threshold.

8. A magnetizing device according to claim 1, wherein the cooling device dissipates heat on one side of the magnetizing finger.

9. A magnetizing device according to claim 1, wherein the cooling device comprises a cooling body that is thermally coupled to the coil core.

10. A magnetizing device according to claim 9, wherein the cooling body is coupled to the coil core through physical contact.

11. A magnetizing device according to claim 1, wherein a cooling body of the cooling device comprises a cooling surface carrier that can have a cooling gas applied to it.

12. A magnetizing device according to claim 11, wherein the cooling surface carrier is designed to deflect the cooling gas.

13. A magnetizing device according to claim 12, wherein the cooling surface carrier has a hollow body and that cooling gas can be applied to its cooling surfaces.

14. A magnetizing device according to claim 11, wherein the cooling gas is a cold gas from a cold gas flow produced through the adiabatic expansion of a gas.

15. A magnetizing device according to claim 14, wherein the cold gas flow can be produced through irreversible adiabatic expansion according to the Joule-Thomson Effect.

16. A magnetizing device according to claim 14, wherein the cold gas flow has a temperature of less than 0° C.

17. A magnetizing device according to claim 1, wherein the temperature sensor is disposed on the opposite side of the magnetizing finger to the side on which the heat is dissipated by the cooling device.

18. A magnetizing device according to claim 1, wherein the temperature sensor is in thermal contact with an encapsulating material surrounding the coil core.

19. A magnetizing device according to claim 17, wherein the temperature sensor is disposed close to a second end of the coil core located opposite a first end of the coil core that is cooled by the cooling device.
